(19) United States
(12) Patent Application Publication
(10) Pub. No.: US 2018/0115821 A1
(43) Pub. Date: Apr. 26, 2018

(54) Speaker Box

(71) Applicant: Wei Chen, Shenzhen (CN)

(72) Inventor: Wei Chen, Shenzhen (CN)

(73) Assignee: AAC Technologies Pte. Ltd., Singapore city (SG)

(21) Appl. No.: 15/417,194

(22) Filed: Jan. 26, 2017

(30) Foreign Application Priority Data
Oct. 26, 2016 (CN) 201621192857.9

(51) Int. Cl. H04R 1/28; H04R 1/02

(52) U.S. Cl. CPC H04R 1/2888; H04R 1/025

(57) ABSTRACT

A speaker box is disclosed. The speaker box includes a housing having an accommodation space, a speaker unit accommodated in the accommodation space, a steel sheet injected in the housing and covering the opening; and a front cavity formed by the steel sheet, the diaphragm and the housing. The housing has an opening located above the diaphragm and an opening wall encircling the opening. The speaker unit includes a diaphragm having a moving element accommodated in the opening and a fixed part. The housing further includes an extension part formed and extending from the opening wall to the front cavity. The extension part combines with the injection of steel sheet, at least part of the extension is located on an upper side of the moving element and does not influence the normal vibration of the moving element.

### FIELD OF THE PRESENT DISCLOSURE

The present disclosure relates to the field of electro-acoustic transducers, and more particularly to speaker box.

### DESCRIPTION OF RELATED ART

At present, due to limitation of space of the stack of the whole machine, the injected steel sheet structure needs to be adopted for the front cavity of majority of speaker box to save space. Specifically, the speaker box includes a housing with accommodation space, a speaker unit accommodated in the accommodation space and a steel sheet injected in the housing. The steel sheet is located on the upper side of the speaker unit. The speaker unit includes diaphragm. The steel sheet, the housing and the diaphragm together encircle the front cavity. When the volume of the speaker unit is large, the area of the steel sheet is made large correspondingly. When the speaker unit works, the strength of the steel sheet is restricted, it is easy to cause the vibration of housing and lead the audio distortion. The existing solution has the following three types: 1) change steel sheet of better material and increase the strength of steel sheet. But it is hard to find this kind of material and the material with high hardness is not good to be molded; 2) Increase the thickness of the steel sheet, but it will lead the increase of thickness of the speaker box. Due to the limitation of stack of the direction of height of the whole machine, the space available for assembling speaker box is limited; and 3) foam or PET sheet is stuck on the external side of the steel sheet used for absorbing shocks, but this method will increase the thickness of the speaker box.

Thereof, it is necessary to disclose and provide an improved speaker box to overcome the above-mentioned disadvantages.

### BRIEF DESCRIPTION OF THE DRAWING

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an isometric and assembled view of a speaker box in accordance with an exemplary embodiment of the present disclosure.

FIG. 2 is an illustration of a housing of the speaker box in FIG. 1.

FIG. 3 is a cross-sectional view of the speaker box taken along line A-A in FIG. 1.

FIG. 4 is an enlarged view of part B in FIG. 3.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

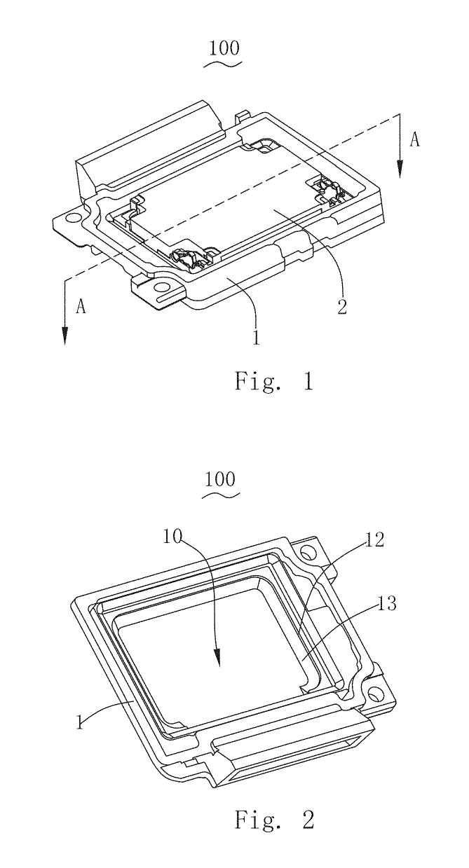

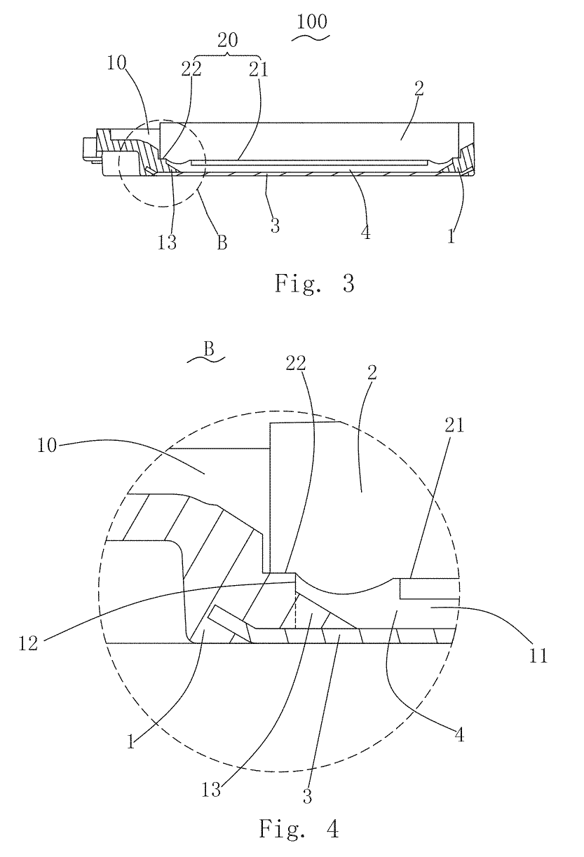

As shown in FIGS. 1-4, a speaker box 100 in accordance with an exemplary embodiment of the present disclosure includes a housing 1 with an accommodation space 10 and a speaker unit 2 accommodated in the accommodation space 10. The speaker unit 2 includes a diaphragm 20. The diaphragm 20 includes a movable part 21 and a fixed part 22 used for fixing connection. The housing 1 has an opening 11 located on an upper side of the diaphragm 20 and an opening wall 12 encircling the opening 11. The movable part 21 is accommodated in the opening 11. The speaker box 100 also includes a steel sheet 3 injected on the housing 1 and covering the opening 11. The steel sheet 3, the diaphragm 20 and the housing 1 encircle and form a front cavity 4 of the speaker box 100. The housing 1 also includes an extension part 13 formed by feeding material when the housing is injected and extending from the opening wall 12 to the front cavity 4. The extension 13 injects and combines with the steel sheet 3. At least part of the extension 13 is located on the upper side of the movable part 21 and does not influence the normal vibration of the movable part 21. Optionally, a thickness of the extension 13 is reduced gradually from the opening wall 12 to the front cavity 4.

The extension part 13 formed by filling material combines with the steel sheet 3 through injection, and therefore the contact area between the steel sheet 3 and the front cavity 4 is reduced to avoid the vibration of the housing. At the same time, the configuration does not change the material of steel sheet 3 and housing 1 and influence the internal assembly relationship of speaker box 100 and the assembly of speaker box in the whole machine neither. It only needs to change a little in the original mold. The cost of changing is low and will not increase process difficulty. It needs to explain specially: the dotted guides in FIG. 4 are to let reader understand forming structure of extension part 13 better.

A decorative pattern of the steel sheet 3 is formed in the area combining and injecting with the extension part 13. The depth of decorative pattern is 0.002 mm-0.02 mm. The configuration of decorative pattern increases the roughness degree of surface of the steel sheet 3, and enhances the injection molding of steel sheet 3 with the plastics of housing to prevent the separation of failure.

In addition, except for the plan that the decorative pattern of steel sheet 3 is set on the area of injecting and combining with the extension part 13. The steel sheet 3 is combined with the extension part 13 by adopting Nano molding process. The binding force between the steel sheet 3 and the extension part can be guaranteed by adopting Nano molding process. The technology of combining the metal and plastics by adopting Nano technology is called as Nano molding technology (NMT). Firstly Nano meter treatment metal surface and then inject plastics on the metal surface to combine the magnesium, stainless steel, titanium etc metals with hard resin to realize the integrated molding. Japan Taiseiplas invented Nano molding technology in 2002.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box including:
a housing having an accommodation space, and having an opening located above the diaphragm and an opening wall encircling the opening;
a speaker unit accommodated in the accommodation space, the speaker unit including a diaphragm having a moving element accommodated in the opening and a fixed part;
a steel sheet injected in the housing and covering the opening;
a front cavity formed by the steel sheet, the diaphragm and the housing; wherein
the housing further includes an extension part formed and extending from the opening wall to the front cavity, the extension part combines with the injection of steel sheet, at least part of the extension is located on an upper side of the moving element and does not influence the normal vibration of the moving element.

2. The speaker box as described in claim 1, wherein a thickness of the extension part from the opening wall to inside of the front cavity reduces gradually.

3. The speaker box as described in claim 1, wherein a decorative pattern of the steel sheet is provided on the injection area of combining with the extension part.

4. The speaker box as described in claim 3, wherein a depth of the decorative pattern is 0.002 mm-0.02 mm.

5. The speaker box as described in claim 1, wherein the steel sheet and the extension part are combined by adopting Nano injection molding process.
